(19) United States
(12) Patent Application Publication
(10) Pub. No.: US 2009/0089537 A1
(43) Pub. Date: Apr. 2, 2009

(54) APPARATUS AND METHOD FOR MEMORY ADDRESS TRANSLATION ACROSS MULTIPLE NODES

(75) Inventors: Christopher A. Vick, San Jose, CA (US); Anders Landin, San Carlos, CA (US); Olaf Manczak, Hayward, CA (US); Michael H. Paleczny, San Jose, CA (US); Gregory M. Wright, Mountain View, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 11/864,851

(22) Filed: Sep. 28, 2007

(51) Int. Cl. G06F 12/10

(52) U.S. Cl. 711/203; 711/E12.058; 711/E12.09

(57) ABSTRACT

A method for translating memory addresses in a plurality of nodes, that includes receiving a first memory access request initiated by a processor of a first node of the plurality of nodes, wherein the first memory access request comprises a process virtual address and a first memory operation, translating the process virtual address to a global system address, wherein the global system address corresponds to a physical memory location on a second node of the plurality of nodes, translating the global system address to an identifier corresponding to the second node, and sending a first message requesting the first memory operation to the second node based on the identifier, wherein the second node performs the first memory operation on the physical memory location.

### BACKGROUND

In multi-node computer systems, it is often desirable to share memory among the nodes, i.e., to provide some form of distributed shared memory (DSM) in which a process executing on one node may access data stored in the memory of one or more other nodes. The DSM may be implemented in software, hardware, or a combination of hardware and software.

Software implementations of DSM generally fall into two categories, operating system based and library based. Operating system based implementations typically use page replication to allow access to remote data by copying a remote virtual memory page into a local virtual memory page, and then accessing the local page directly. In general, in such implementations, the DSM is viewed as a shared global virtual address space in which virtual pages may be mapped to different nodes. When a page fault occurs during execution of a virtual memory access (i.e., a load or store) by process on a node, if the needed virtual page is mapped to a different node, the needed virtual page is copied from the other node into the physical memory of the node where the page fault occurred. Library-based implementations typically use a message passing paradigm to access the remote data or implement a page replication scheme similar to that of the operating system based implementations but with the replication being explicit rather than hidden in the virtual memory subsystem.

Many different approaches to hardware implementation of DSM exist. For example, in the Alewife system created at the Massachusetts Institute of Technology, the DSM is treated as a single global physical address space (i.e., the nodes share the same physical address space). All physical memory accesses on a node, both to local memory and to remote memory, are channeled to a Communications and Memory Management Unit (CMMU). The CMMU determines whether to route a memory request to local physical memory or to send a message to a remote CMMU requesting access to physical memory on a remote node. The remote CMMU copies the requested physical memory contents to a special local cache, where the requested memory operation is performed. This special local cache is kept fully coherent using a software-assisted directory coherence protocol.

In another example, the FLASH system created at Stanford University uses a co-processor called MAGIC to handle all intra-node and inter-node communication. Similar to the Alewife system, the DSM is treated as a single global physical address space. The MAGIC processor receives messages which direct it to perform local instructions sequences which execute data movement and state transitions to form a cache coherence protocol. Effectively, the MAGIC processor intercepts CPU loads and stores and triggers the execution of an internal protocol routine for each load or store. The protocol routines create a directory based cache coherence mechanism, storing the directory in the main memory of the node.

Remote Direct Memory Access (RDMA) systems implemented using Network Interface Cards (NICs) is an example of a hardware and software implementation of DSM. NICs which support RDMA have a programmable translation engine in the NIC to allow block copy requests to execute directly to local memory on a node. A process executing on the node may explicitly request a block copy from a virtual address on another node to a virtual address on the node using an RDMA request or a block copy from a virtual address on the node to a virtual address on another node. The translation engine on the NIC is programmed by the NIC driver software to convert a process virtual address (i.e., a virtual address in the virtual address space of the process) in the RDMA request to a local physical address for a local buffer which either receives the requested block of data from the other node or holds the block of data to be sent to the other node. The NIC typically handles the transfer of the block of data between the nodes.

### SUMMARY

In general, in one aspect, the invention relates to a method for translating memory addresses in a plurality of nodes, that includes receiving a first memory access request initiated by a processor of a first node of the plurality of nodes, wherein the first memory access request comprises a process virtual address and a first memory operation, translating the process virtual address to a global system address, wherein the global system address corresponds to a physical memory location on a second node of the plurality of nodes, translating the global system address to an identifier corresponding to the second node, and sending a first message requesting the first memory operation to the second node based on the identifier, wherein the second node performs the first memory operation on the physical memory location.

In general, in one aspect, the invention relates to a system that includes a first node that includes a first physical memory and a first processor, a second node that includes a second physical memory and a second processor, and a first interconnect device operatively connected to the first processor, the first physical memory, and the second node, wherein the first processor is configured to initiate a first memory access request that includes a process virtual address and a first memory operation, wherein the process virtual address is translated to a global system address, and wherein the global system address corresponds to a physical memory location in the second physical memory, and the first interconnect interface device is configured to receive the global system address and the first memory operation, translate the global system address to an identifier corresponding to the second node and a first virtualized address of the physical memory location in the second physical memory, and send a first message requesting the first memory operation to the second node based on the identifier, wherein the first message comprises the first virtualized address, wherein the second node performs the first memory operation on the physical memory location in the second physical memory.

In general, in one aspect, the invention relates to an apparatus for memory address translation, the apparatus that includes logic to receive a first memory access request initiated by a first processor on a first node, wherein the first memory access request comprises a global system address and a first memory operation, and wherein the global system address corresponds to a physical memory location on a second node, logic to translate the global system address to an identifier corresponding to the second node, and logic to send a first message requesting the first memory operation to the second node based on the identifier, wherein the second node performs the first memory operation on the physical memory location.

Other aspects of the invention will be apparent from the following description and the appended claims.

### BRIEF DESCRIPTION OF DRAWINGS

FIGS. 1-3 show schematic diagrams in accordance with one or more embodiments of the invention.

FIGS. 4 and 5 shows flowcharts in accordance with one or more embodiments of the invention.

FIG. 6 shows a flow diagram in accordance with one or more embodiments of the invention.

FIG. 7 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for sharing physical memory among multiple nodes of a distributed computer system. Specifically, embodiments of the invention allow a memory access request (i.e., a load or store operation) addressing a virtual memory location on one node to be directly executed in the physical memory of another node. Thus, an application in execution may use a virtual address to access memory of another node. A translation is performed from the virtual address to the global system address without modification to components performing virtual to physical address translations. The global system address may be used to identify the remote node and the physical address of the remote node.

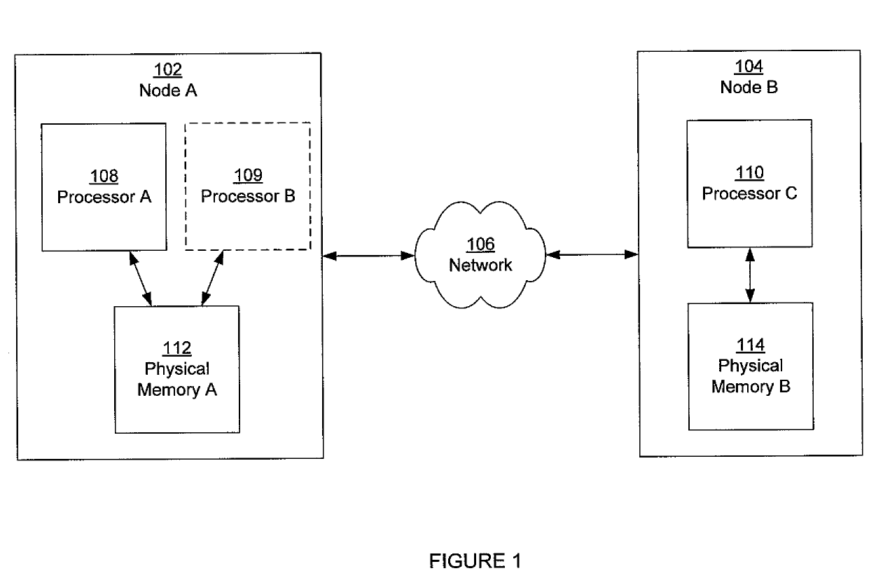

FIG. 1 shows a schematic diagram of a system in accordance with one or more embodiments of the invention. As shown in FIG. 1, the system includes multiple nodes (e.g., node A (102), node B (104)) connected via a network (106). The network (106) may be a local area network, a wide area network, or any other type of network known in the art. Alternatively, rather than a network, the nodes may be connected through connection mechanism known in the art, such as a wired or wireless direct connection.

Each node (e.g., node A (102), node B (104)) includes at least one processor (e.g., processor A (108), processor B (109), processor C (110)), and one or more physical memory devices (e.g., physical memory A (112), physical memory B (114)). Further, some of the nodes (e.g., node A (102)) may be a multiprocessor and/or multicore system while other nodes (e.g., Node B (104)) have a single processor (e.g., processor C (109)).

A processor (e.g., processor A (108), processor B (109), processor C (110)) includes functionality to execute instructions of an application. Some of the instructions that a processor includes functionality to execute are memory operations. The processor includes functionality to execute a memory operation by generating a memory access request to access memory.

A memory access request includes, but is not limited to, a load or store operation for physical memory (e.g., physical memory A (112), physical memory B (114)) in accordance with one or more embodiments of the invention. A load instruction is an instruction to obtain data from a location in memory. A store instruction is an instruction to store data to a location in memory.

The data requested in a memory access request may be physically located in memory available in a local node or a remote node. In one or more embodiments of the invention, a node is local when the node has the processor that generates the memory access request. The node is remote when the node does not have the processor that generates the memory access request. In one or more embodiments of the invention, the generation of the memory access request by a processor is not changed when the physical memory referenced is on a remote node.

In one or more embodiments of the invention, the devices used for the processors (e.g., processor A (108), processor B (109), processor C (110)) may be of heterogeneous types. Further, when more than one processor is on a node, the processors on the node may have a heterogeneous type. Similarly, in one or more embodiments of the invention, the devices used for the physical memory (e.g., physical memory A (112), physical memory B (114)) may be of heterogeneous types.

In general, when a processor performs a memory access request, the processor uses a process virtual address to specify a memory location. A process virtual address is in the process virtual address space. An address space is a range of addresses each of which may be used to identify the location of an element of data in physical memory.

Having different address spaces provides different levels of abstraction in the system. For example, an address space may provide an abstraction for the processor as to where physical memory corresponding to a virtual address is located. Because of the abstraction by the virtual address, the processor does not need to know if the physical memory is located on a local node or on a remote node. Furthermore, an address space (i.e., the global system address space (discussed below)) may abstract which remote node has the physical memory corresponding to an address. Thus, individual pages (discussed below) in the physical memory of a remote node may be moved from one remote node to another remote node in a manner which is transparent to the processor making the memory request. Additionally, using a separate layer of abstraction provided by a separate address space (i.e., the system address space (discussed below)), pages may be move within a remote node to different locations in physical memory of the remote node. Finally, in a scenario in which node failures may occur, an abstraction may exist to easily switch a local node from accessing physical memory of a failed node to accessing the physical memory of a replica node without requiring extensive updates to components tracking translations between address spaces. Thus, the address spaces provide a mechanism for a processor to access data when the physical locations of data in physical memory may change.

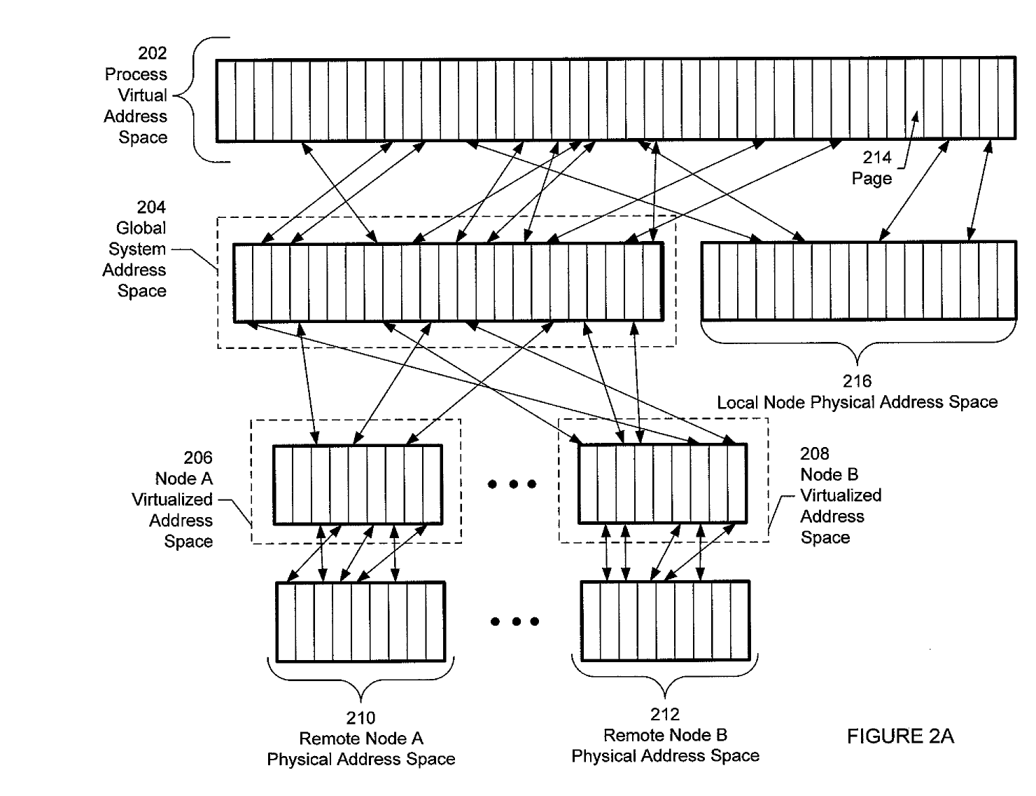

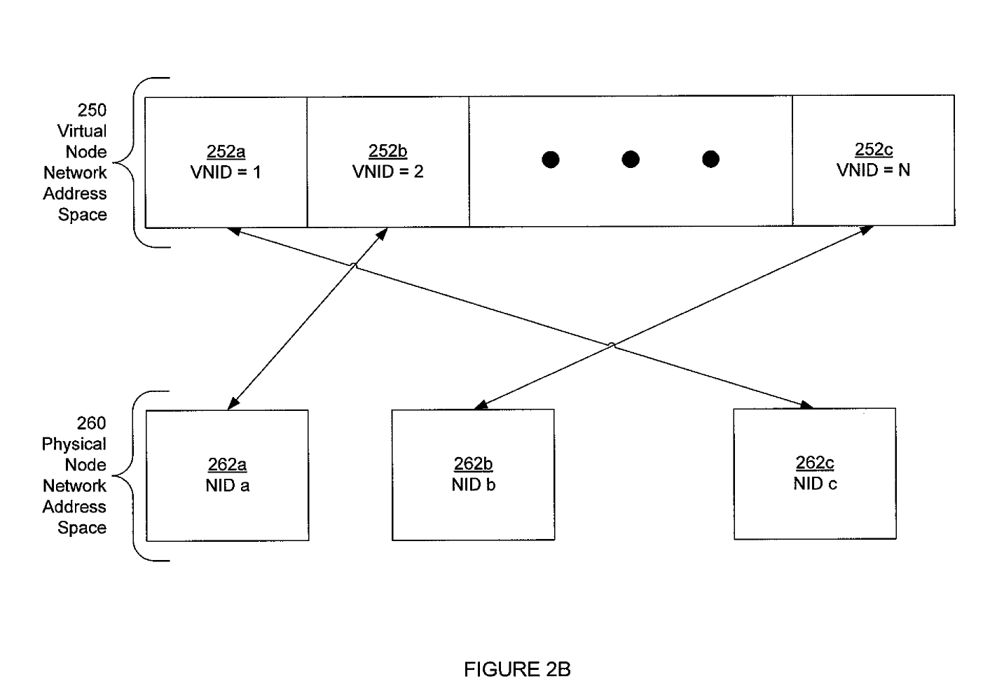

FIGS. 2A and 2B show a schematic diagrams of the address spaces in accordance with one or more embodiments of the invention. In FIG. 2A, the address spaces are denoted as the rectangles with thick borders. Arrows between address spaces represent different mappings of pages in address spaces. In particular, as shown in FIG. 2A, address spaces may be divided into pages (e.g., page (214)). While FIG. 2A shows pages of the same size, pages may be of variable sizes in one or more embodiments of the invention.

In one or more embodiments of the invention, the address spaces for memory may include a process virtual address space (202), a global system address space (204), a node virtualized address space (e.g., node A virtualized address space (206), node B virtualized address space (208)), and a node physical address space (e.g., local node physical address space (218), remote node A physical address space (210), remote node B physical address space (212)). In one or more embodiments of the invention, as shown in FIG. 2B, the address spaces for nodes may also include a virtual node network address space (250) and a physical node network address space (260) (e.g., a virtual Node 1 which maps to physical node A in the node virtualization table). Each of the address spaces are described below.

The process virtual address space (202) is an address space that a process of an application may use to request data without specifying the actual physical location in which the data is located in physical memory. For the purpose of the description below, the memory page in which the data requested for access by a process resides is called a requested page. The process virtual address space (202) abstracts from the process not only where the requested page is located on a node, but also whether the requested page is on a local node or a remote node. Typically, the process virtual address space (202) provides a contiguous view of memory for a process that is larger than the physical memory allocated to the process. Thus, using a process virtual address, a process may request access to the requested page without knowing the physical layout or the amount of memory available.

The process virtual addresses in the process virtual address space (202) may be mapped into global system addresses in the global system address space (204) or the local node physical address space (216). As shown by the arrows between pages in the process virtual address space (202) and the global system address space (204) in FIG. 2A, pages from the process virtual address space (202) may be mapped in different order and/or non consecutively to pages in the global system address space (204) or the local node physical address space (216).

The local node physical address space (216) is the range of physical addresses for the local node. Specifically, each physical address in the local node physical address space (216) may be used to access physical memory at the location specified by the physical address on the local node. More specifically, in one or more embodiments of the invention, the physical address specifies the exact location in physical memory of the requested data.

Continuing with FIG. 2A, in one or more embodiments of the invention, a global system address space (204) provides a contiguous view of memory available to all processors on all nodes to access. Specifically, memory available for other nodes to use in the global system address space (204) appears as a single large memory. Specifically, the global system address space (204) may be used to abstract which node has the physical memory with the requested page.

In one or more embodiments of the invention, the global system addresses in the global system address space (204) may have the same format as physical addresses in the local node physical address space (216). Specifically, in one or more embodiments of the invention, the global system addresses have the same format as physical addresses on the node. For example, the global system addresses may have the same number of bits set for the page offset as the physical addresses.

Further, in one or more embodiments of the invention, the global system address space (204) may span a range of addresses not in use by the local node physical address space. For example, if the local node physical address space (216) has addresses in the range of zero to five hundred, the global system addresses may be in the range of five hundred and one or six hundred to three thousand. Thus, translations to the global system address space (204) may be performed identically as translations to the local node physical address space (216). In one or more embodiments of the invention, the global system address space (204) abstracts which remote node has the memory location represented by the global system address. For example, an operating system may request allocation of a page from the global system address space (204) without knowing which node has the physical page corresponding to the global page. Thus, physical pages may be moved from one node to another node without updating the global system address space (204).

Continuing with FIG. 2A, in one or more embodiments of the invention, the global system address space (204) corresponding to memory locations on remote nodes may be mapped into the system address space (not shown) by translating node addresses from the virtual node network address space (250) into the physical node network address space (260) (e.g., by using a node virtualization table (explained below)). The system address space may be used to identify the node that has the physical memory with the requested page. In one or more embodiments of the invention, the system address space is composed of remote node virtualized address spaces (e.g., remote node A virtualized address space (206), remote node B virtualized address space (208)). A virtualized address space (e.g., remote node A virtualized address space (206), remote node B virtualized address space (208)) has virtualized addresses that specify the virtual locations of memory on a remote node.

A virtualized address is a system address that is assigned to a remote node and may be used by the remote node to access physical memory. Specifically, the virtualized address in the virtualized address space abstracts where a requested page is located on a remote node. Thus, the remote node virtualized address space (e.g., remote node A virtualized address space (206), remote node B virtualized address space (208)) abstracts the memory layout of the remote node. Because the remote node publishes mappings between the virtualized address and the global system address, pages in the physical memory may be moved to a different physical location on the remote node without affecting how local nodes specifies the memory location in accordance with one or more embodiments of the invention. For example, the remote node may coalesce the pages without requiring that the local node be updated with the new addresses of the data.

While FIG. 2A shows the remote node virtualized address spaces as contiguous sections of memory, in one or more embodiments of the invention, the remote node virtualized addresses may be striped across the remote nodes. For example, one node may be assigned the first two pages in the system address space, the third two pages in the system address space, the fifth two pages in the system address space, etc. Another nodes may be assigned the second two pages in the system address space, the fourth two pages in the system address space, the sixth two pages in the system address space, etc.

In one or more embodiments of the invention, the remote node's virtualized address space (e.g., remote node A virtualized address space (206), remote node B virtualized address space (208)) may be mapped into the remote node's physical address space (e.g. remote node A physical address space (210), remote node B physical address space (212)). In general, the virtualized address space (e.g., remote node A virtualized address space (206), remote node B virtualized address space (208)) for the remote node may have the same size or a smaller size than the physical address space (e.g. remote node A physical address space (210), remote node B physical address space (212)) for the remote node. The remote node's physical address space (e.g. remote node A physical address space (210), remote node B physical address space (212)) has physical addresses that specify an exact location in physical memory. Using the remote node's physical address, a remote node can directly access memory without further mapping in accordance with one or more embodiments of the invention.

As previously mentioned, in one or more embodiments of the invention, the address spaces include an address space for abstracting the physical network address of a node. As shown in FIG. 2B, this network node abstraction address space includes a virtual node network address space (250) and a physical node network address space (260) in one or more embodiments of the invention. A virtual node network address space (250) includes contiguous virtual node identifiers (VNIDs) (252a-c). Each VNID (252a-c) may be used to identify a node. In one or more embodiments of the invention, the VNIDs (252a-c) are sequential integers.

Continuing with FIG. 2B, each VNID maps to a node identifier (NID) in the physical node network address space (260). For example, VNID 1 (252a) maps to NID c (262c). In another example, VNID 2 (252b) may map to NID a (262a). In one or more embodiments of the invention, a NID (262a-c) is a physical network address. By having both a virtual node network address space (250) and a physical node network address space (260), embodiments of the invention provide a technique for replacing a physical node with a replica with minimal overhead if the physical node fails.

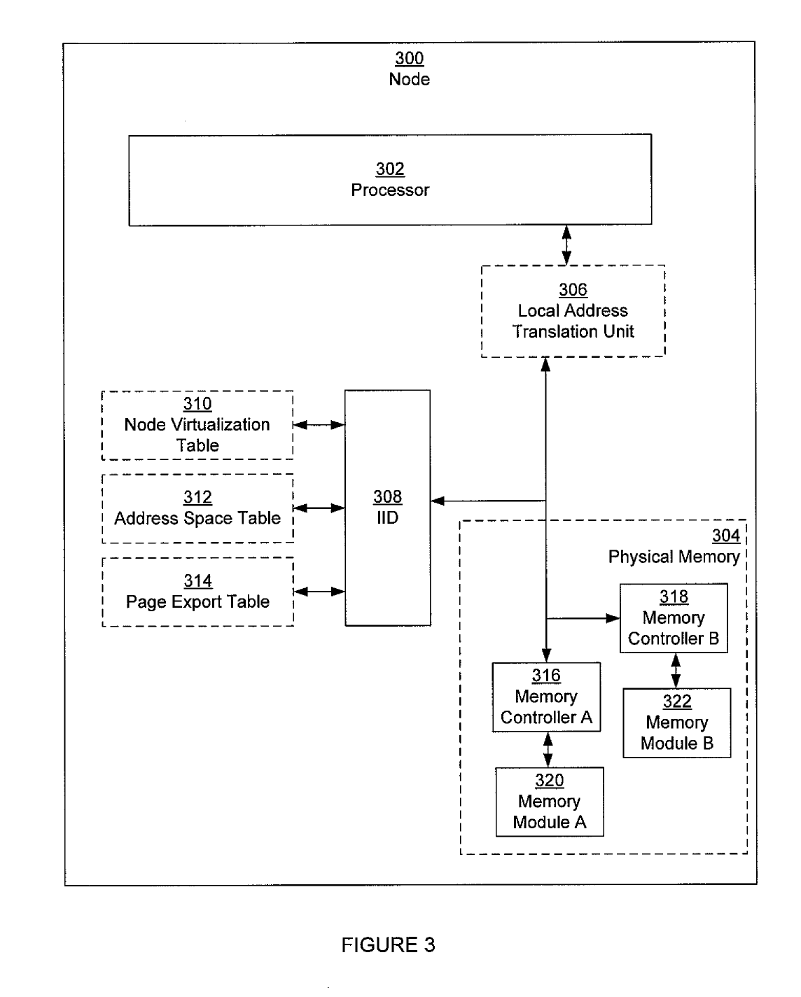

In one or more embodiments of the invention, components in the nodes include functionality to translate between the address spaces. FIG. 3 shows a schematic diagram of a node (300) in accordance with one or more embodiments of the invention. The node (300) may correspond to node A or node B in FIG. 1.

As shown in FIG. 3, the node (300) includes a processor (302), physical memory (304), a local address translation unit (306), an interconnect interface device (IID) (308), an address space table (310), a node virtualization table (312), and a page export table (314) in accordance with one or more embodiments of the invention. Each of these components is described below.

The processor (302) may be, for example, processor A, processor B, or processor C in FIG. 1. Similarly, the physical memory (304) may be physical memory A or physical memory B in FIG. 1. Interposed between the processor (302) and physical memory (304) is a local address translation unit (306) in accordance with one or more embodiments of the invention. The local address translation unit (306) includes functionality to translate process virtual addresses into global system addresses in accordance with one or more embodiments of the invention. In one or more embodiments of the invention, global system addresses may appear to the local address translation unit (306) as if the global system addresses are in the physical address space of the local node. Specifically, the local address translation unit (306) may not be able to distinguish between physical memory is located on a local node and physical memory located on a remote node.

As an example, the local address translation unit (306) may be a memory management unit. In another example, the local address translation unit (306) may be a part of the processor or a part of another device in the node (300). Alternatively, the functionality provided by the local address translation unit (306) may be performed by one or more hardware devices (e.g., processor (302), memory controller (not shown), etc.).

In order to perform the translation (306), the local address translation unit may have a mapping mechanism (not shown) in accordance with one or more embodiments of the invention. The mapping mechanism may be any type of storage mechanism that specifies a physical address for each process virtual address. For example, the mapping mechanism may be a page table and/or a translation lookaside buffer.

In one or more embodiments of the invention, memory access requests are intercepted by the physical memory (304) and the IID (308). Physical memory (304) includes memory modules (e.g., memory module A (320), memory module B (322)) and memory controllers (e.g., memory controller A (316), memory controller B (318)) in accordance with one or more embodiments of the invention.

A memory module (e.g., memory module A (320), memory module B (322)) is a hardware storage medium for storing data. Each memory module (e.g., memory module A (320), memory module B (322)) has the memory locations corresponding to a disjoint range of physical addresses. For example, memory module A (320) may have memory locations corresponding to a range of physical memory addresses from 1 to n while the memory module B (322) has memory locations corresponding to a range of physical memory addresses from n+1 to m.

The memory controller (e.g., memory controller A (316), memory controller B (318)) includes functionality to identify, for the physical memory module connected to the memory controller (e.g., memory controller A (316), memory controller B (318)), whether a physical memory address is within the range of physical memory addresses of the memory module (e.g., memory module A (320), memory module B (322)). If the physical memory address is within the range, then the memory controller (e.g., memory controller A (316), memory controller B (318)) includes functionality to access the memory module (e.g., memory module A (320), memory module B (322)) based on the memory access request from the processor in accordance with one or more embodiments of the invention.

In one or more embodiments of the invention, an IID (308) is also connected to the local address translation unit (306). The IID (308) includes functionality to receive a physical address after the process virtual address is translated by the local address translation unit, determine whether the physical address specifies a global system address, and send message to a remote node requesting that the memory operation be performed in the physical memory of the remote node. The IID (308) may have a remote node identifier, such as a network address, that is separate from a network address of the node (300). Specifically, communication with a destination specified by the remote node identifier may be direct by the network to the IID (308). Further, in one or more embodiments of the invention, the IID (308) includes functionality to receive and process messages requesting memory operations from other nodes. Specifically, the IID (308) includes functionality to access physical memory (304) on behalf of other nodes.

In one or more embodiments of the invention, the IID (308) may be a hardware chip (e.g., an Application-Specific Integrated Circuit) that includes functionality to operate as a memory controller and a network interface card. Alternatively, the functionality provided by the IID may be performed by one or more other hardware components of the node.

Continuing with FIG. 3, the IID (308) is connected to a node virtualization table (310), an address space table (312), and a page export table (314) in accordance with one or more embodiments of the invention. The node virtualization table (310), address space table (312), and page export table (314) may be physically part of the IID (308) or a separate hardware component.

A node virtualization table (310) includes a mapping from the virtual node identifier to a remote node identifier. A virtual node identifier is a mechanism to specify a node when the remote node identifier may change. For example, when a remote node fails, a replica with a different remote node identifier may continue processing messages requesting memory operations. Accordingly, the virtual node identifier may be used to specify the original node until the original node fails and then to specify a remote node. In one or more embodiments of the invention, virtual node identifiers are consecutive integers.

In one or more embodiments of the invention, the node virtualization table (310) has sixteen kilobyte entries with each entry as a fourteen bit physical node identifier. In one or more embodiments of the invention, the node virtualization table (310) is initialized when the node is initiated and changed when a node in the system fails.

An address space table (312) includes a mapping from the global system address space to the virtualized address and a virtual node identifier. In one or more embodiments of the invention, the address space table (312) may have sixteen kilobyte entries with the each entry having a fourteen bit virtual node identifier and the nine bit page identifier. Alternative embodiments of the invention may have different size tables and different allocation of bits to the virtual node identifier and the page identifier. The virtualized address may be formed from the page identifier and offset specified in the global system address.

Further, in one or more embodiments of the invention, all nodes in the system have the same address space table (312) and the same node virtualization table (310). In alternative embodiments of the invention, each node may only have entries in the address space table (312) and in the node virtualization table (310) according to whether the memory is allocated to the node.

Continuing with FIG. 3, a page export table (314) includes mappings from a remote node's virtualized address space to the remote node's physical address space. Specifically, the page export table (314) may be used to identify the physical memory addresses from virtualized memory addresses in incoming memory access requests. In one or more embodiments of the invention, the page export table (314) includes only mappings of pages that are currently exported. In one or more embodiments of the invention, the page export table has five hundred and twelve entries.

In order to use memory on a remote node, the address space table is updated with the mapping between the global system address and the virtualized address. Specifically, when allocating memory, an operating system may choose to allocate the memory from a remote node by requesting an allocation by the operating system on the remote node of one or more pages in the global system address space that do not correspond to any of the local node's physical addresses. The local operating system sends the memory mapping request via the local node IID to the remote node IID in accordance with one or more embodiments of the invention. The remote node IID may, for example, request the memory mapping from the remote node's operating system. In response, the remote node IID receives both the physical memory address for the requested memory for its page export table, and the global system address for the requested memory to forward to other nodes. Accordingly, the remote node's page export table may be updated, for example, to map the physical memory address to the node's virtualized address. Further, the remote node's address space table may be updated to assign the global system address to the virtualized address and virtual node identifier of itself. The mapping in the address space table is sent to the local node. In turn, the local node may update the address space table with the mapping provided by the remote node. When the mapping is in the address space table, the local node can use the physical memory of the remote node in accordance with one or more embodiments of the invention.

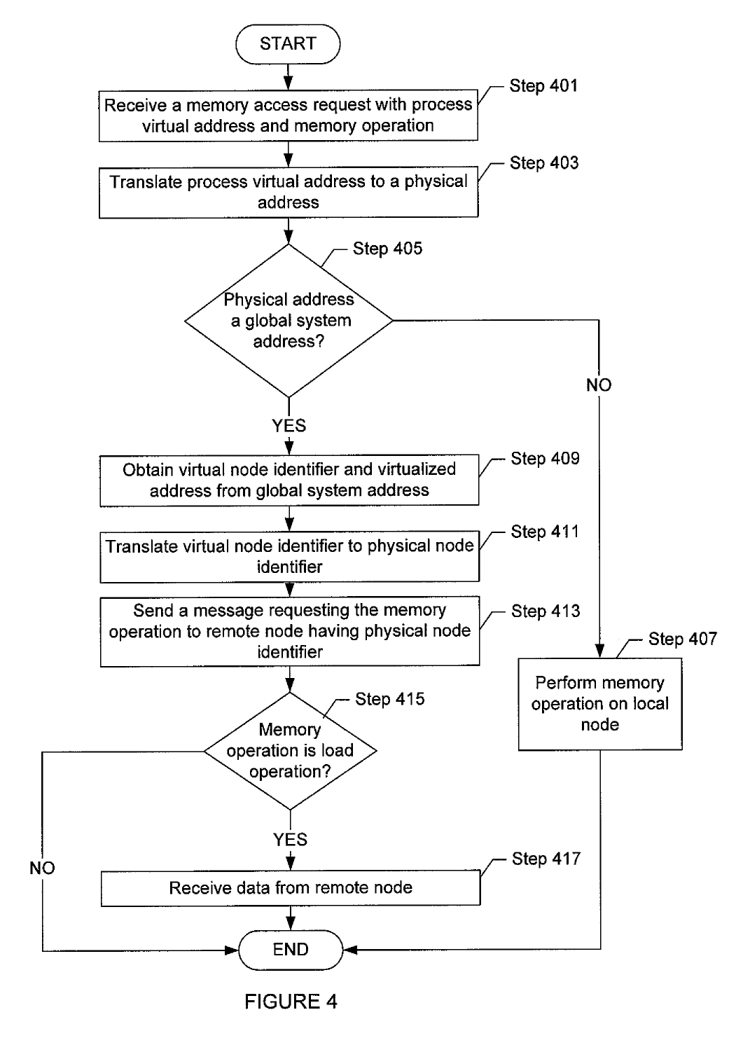

FIG. 4 shows a flowchart of a method for performing memory address translation on a node in order to access physical memory on a remote node in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. In addition, steps such as store acknowledgements have been omitted to simplify the presentation.

Initially, a memory access request that includes a process virtual address and a memory operation is received from a processor (Step 401). The memory access request may be generated by a processor when executing an instruction that specifies a memory operation on a process virtual address. Specifically, the processor may forward the memory operation and the process virtual address, for example, to a memory subsystem, such as the local address translation unit.

The process virtual address is translated to a physical address by a local address translation unit. (Step 403). The local address translation unit may translate the process virtual address into the physical address using any technique known in the art for translating a process virtual address into a physical address. Thus, in one or more embodiments of the invention, the local address translation unit is not modified to account for the possibility of physical addresses on remote nodes.

After performing the translation, the memory operation and the physical address are sent to the memory controllers and the IID. For example, the memory operation and the physical address may be placed on a memory bus monitored by the memory controllers and the IID.

Next, a determination is made whether the physical address is a global system address (Step 405). In one or more embodiments of the invention, the IID tracks the range of physical addresses that are mapped to the global system address space. Accordingly, in one or more embodiments of the invention, the IID monitors memory addresses on a memory bus and determines whether a memory address is within this range.

If the physical address does not specify a global system address, then the physical address is a physical address on the local node. Accordingly, the memory operation is performed on the local node in accordance with one or more embodiments of the invention (Step 407). Specifically, memory controllers connected to memory modules of the local node also monitor the memory bus and determine whether the physical address is in the range of physical addresses mapped to the corresponding memory module. If the physical address is in the physical address range of the corresponding memory module, the memory operation is performed on the location specified by the physical address in accordance with one or more embodiments of the invention.

Alternatively, if the physical address is a global system address, then the virtual node identifier and the virtualized address is obtained from the global system address in accordance with one or more embodiments of the invention (Step 409). Specifically, in one or more embodiments of the invention, the IID receives the memory operation and the global system address and uses the global system address to locate a virtual node identifier and a virtualized address. In one or more embodiments of the invention, the global system address may have a first set of bits specify a page number and a second set of bits specify an offset into the page. The page number denotes the page having the memory location and the offset denotes the relative position of the memory location in the page. The page number in the global system address may be used as an index into the address space table to obtain the page number for the virtualized address and the virtual node identifier. In one or more embodiments of the invention, the offset may remain the same.

Further, the virtual node identifier is translated into the physical node identifier in accordance with one or more embodiments of the invention (Step 411). The physical node identifier may be obtained, for example, from the node virtualization table using the virtual node identifier as an index into the table.

A message requesting the memory operation is sent to the remote node having the physical node identifier (Step 413). Specifically, the IID generates a message to the remote node having the physical node identifier. The message identifies the memory operation to be performed and includes the virtualized address. In one or more embodiments of the invention, the message is sent using any communication method known in the art. The format of the message may be dependent on the communication protocols required by the type of connection between the nodes.

When the type of connection is an internet connection, the physical node identifier may be a network address. Further, in one or more embodiments of the invention, each IID may have a separate network address than the node upon which the IID is located. In such scenario, the IID may act as a network interface card and the physical node identifier specifies the IID.

Continuing with FIG. 4, a determination may be made whether the memory operation is a load operation (Step 415). If the memory operation in the message is a load operation, then data is received from the remote node in accordance with one or more embodiments of the invention (Step 417). The IID may receive the data from the network and send the data to the processor in a manner similar to a memory controller in accordance with one or more embodiments of the invention. Thus, the memory operation corresponding to a load instruction may be considered complete when the data is sent to the processor.

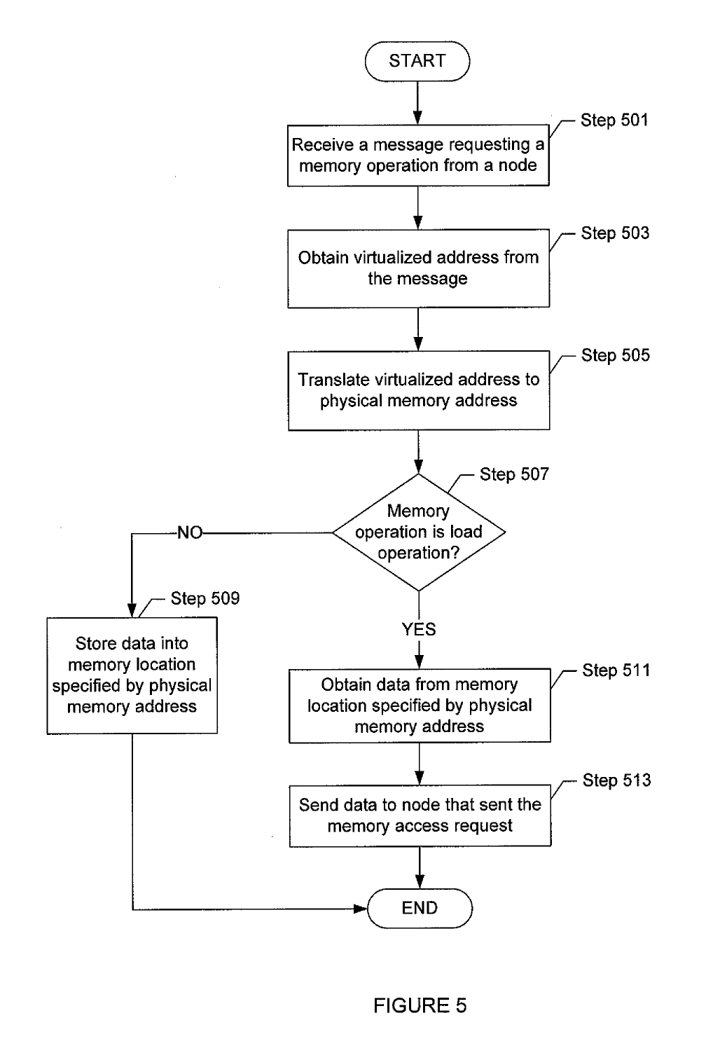

FIG. 5 shows a flowchart of a method to process a message requesting a memory operation on a remote node in accordance with one or more embodiments of the invention. While the various steps in this flowchart are presented and described sequentially, one of ordinary skill will appreciate that some or all of the steps may be executed in different orders and some or all of the steps may be executed in parallel.

Initially, a message requesting a memory operation is received from a node in accordance with one or more embodiments of the invention (Step 501). In one or more embodiments of the invention, a virtualized address is obtained from the message (Step 503). Specifically, in one or more embodiments of the invention, the format of message may be standardized such that the remote node and the local node agree as to which bits have the virtualized address or denote the virtualized address. After receiving the message, the remote node may extract the virtualized address according to the standardized format.

The virtualized address is translated into a physical address on the remote node in accordance with one or more embodiments of the invention (Step 505). Translating the virtualized address into the physical address may be performed, for example by using a page export table. Translating the virtualized address into the physical address may include extracting an index into the page export table from the virtualized address, using the index to locate the page number of a physical page in the page export table, and appending an offset from the virtualized address to the corresponding physical page number to generate the physical address.

A determination may be made whether the memory operation requested by the message is a load operation in accordance with one or more embodiments of the invention (Step 507). Similar to extracting the virtualized address, the memory operation may be extracted from the message. The IID may then initiate the load operation.

If the memory operation is not a load operation, then data from the message is stored in the memory location specified by the physical memory address (Step 509). Specifically, the physical address, data in the message, and store operation may be placed on the memory bus and processed by a memory controller.

Alternatively, if the memory operation is a load operation, then data is obtained from the memory location specified by the physical memory address (Step 511). The memory controller may return the data from the memory location. The data may be intercepted, for example, by the IID to send to the node requesting the memory operation.

Accordingly, in one or more embodiments of the invention, the data obtained from the memory access request is sent to the node that sent the message requesting the memory operation (Step 513). Sending the data may be performed in a manner similar to sending the request message. For example, the physical node identifier may be used as a destination address for a message that includes the data. Further, sending the data to the node requesting the data may include an identifier of the request, such as the virtualized address of the data.

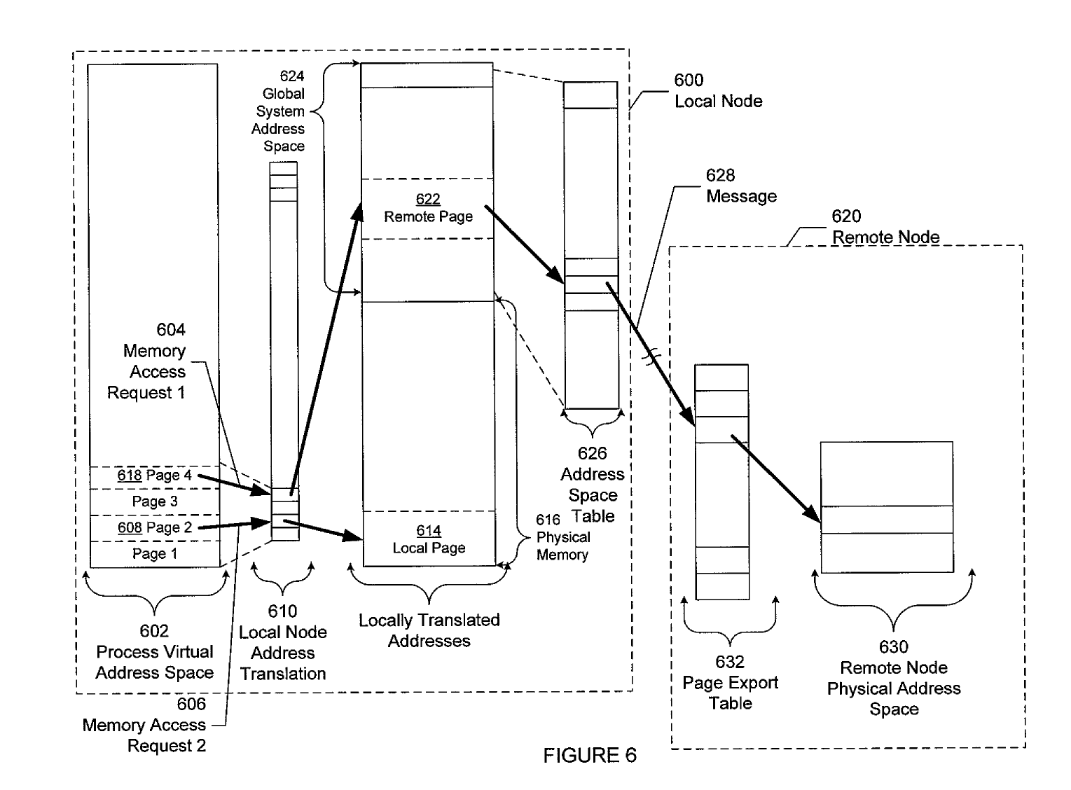

In the following example, consider the scenario in which an application is developed and compiled with the assumption that only local memory is used. Each memory operation in the application uses process virtual addresses. The application is executed on a node (i.e., the local node) by a processor on the node. FIG. 6 shows an example of a flow diagram of how a local node (600) may perform memory access in accordance with one or more embodiments of the invention.

In the example, the processor uses the process virtual address space (602) to generated memory access requests (e.g., memory access request 1 (604), memory access request 2 (606)). Specifically, instructions of the application specify a request for memory using the process virtual address space (602).

Thus, for example, the processor may generate the memory access request 2 (606) to request a memory operation on a process virtual memory address in virtual page 2 (608). The local node translation unit (610) translates the process virtual address into a physical address. A memory controller (not shown) on the local node (602) receives the memory access request and the physical address. To the memory controller, the physical address is a physical address in the local physical page (614) in the physical memory of the local node (616). Accordingly, the memory controller performs the memory operation on the physical address in the local physical page (614).

Continuing with the example, in a similar manner to generating memory access request 2 (606), the processor may generate memory access request 1 (604) to request a memory operation on a process virtual memory address in virtual page 4 (618). The local node address translation unit (610) translates the process virtual address to obtain the corresponding physical address (612).

In the example, the IID (not shown) on the local node (600) receives the memory access request 1 (604) and the physical address. The IID recognizes that the physical address is a global system address specifying a remote page (622) in the global system address space (624). Thus, the IID on the local node (600) identifies the corresponding virtualized address and virtual node identifier for the remote page (622) using the address space table (626). The IID on the local node (600) may further use a node virtualization table (not shown) to identify the physical node identifier corresponding to the virtual node identifier. The IID on a local node (600) sends a message requesting the memory operation (628) to the remote node (620) using the physical node identifier. The message (628) includes the virtualized address and identifies the memory operation to be performed. If the memory operation to be performed is a store operation, the message (628) also includes the data to be stored.

In the example, an IID (not shown) on the remote node (620) receives the message (628) and extracts the memory operation and the virtualized address. The IID then translates the virtualized address into a physical address in the remote node physical address space (630) using a page export table (632). The IID then places the memory operation and the physical address on a memory bus to cause the requested memory operation to be performed by a memory controller on the remote node (620). Accordingly, the memory controller on the remote node (620) performs the memory operation on the location specified by the physical address.

In the example, the memory controllers and the IID on the local node (600) may receive all memory access requests and physical addresses. Each memory controller may determine whether the physical address is within the range of physical addresses assigned to the memory controller. Similarly, the IID may determine whether the physical is in an address range of the global system address space. The memory controllers or the IID that is assigned physical address performs the memory operations. The remaining memory controllers or IID may ignore the memory access request.

As shown in the example, embodiments of the invention allow an application, processor, and local node address translation to perform memory operations on physical memory locations on remote nodes as if the memory operation is on the local node. To the processor and local node address translation, the size of the physical memory is the size of the local node's physical memory with the size of all of the physical memory published by remote nodes.

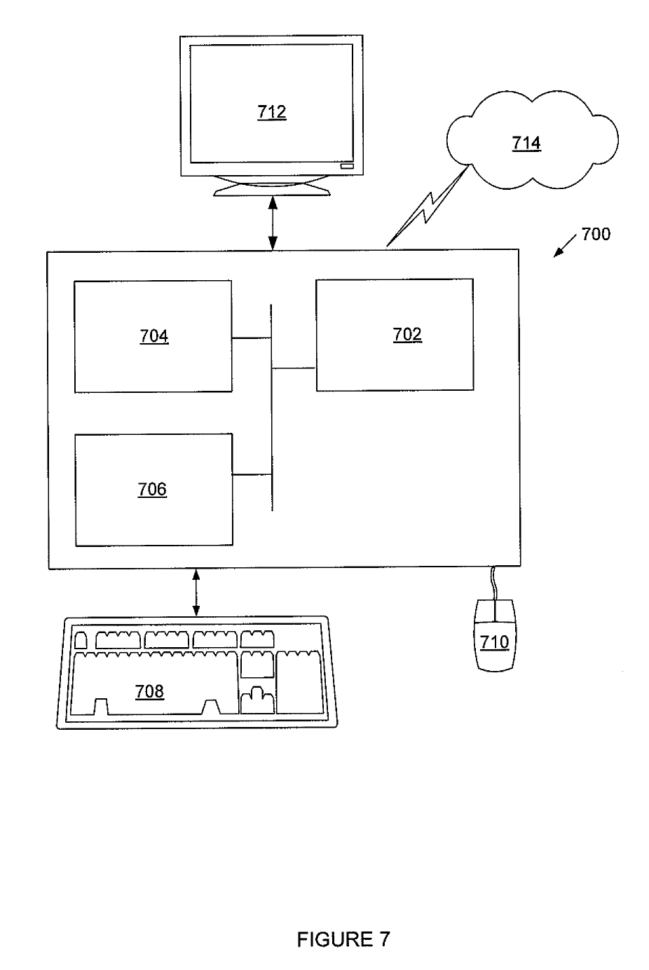

Embodiments of the invention may be implemented on virtually any type of computer regardless of the platform being used. For example, as shown in FIG. 7, a computer system (700) includes a processor (702), associated memory (704), a storage device (706), and numerous other elements and functionalities typical of today's computers (not shown). The computer (700) may also include input means, such as a keyboard (708) and a mouse (710), and output means, such as a monitor (712). The computer system (700) is connected to a local area network (LAN) or a wide area network (e.g., the Internet) (714) via a network interface connection (not shown). Those skilled in the art will appreciate that these input and output means may take other forms.

Further, those skilled in the art will appreciate that one or more elements of the aforementioned computer system (700) may be located at a remote location and connected to the other elements over a network. Further, embodiments of the invention may be implemented on a distributed system having a plurality of nodes, where each portion of the invention (e.g., local node IID, remote node IID, etc.) may be located on a different node within the distributed system. In one embodiment of the invention, the node may be a computer system. Alternatively, the node may be a processor with associated physical memory. The node may alternatively be a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for translating memory addresses in a plurality of nodes, comprising:
receiving a first memory access request initiated by a processor of a first node of the plurality of nodes, wherein the first memory access request comprises a process virtual address and a first memory operation;
translating the process virtual address to a global system address, wherein the global system address corresponds to a physical memory location on a second node of the plurality of nodes;
translating the global system address to an identifier corresponding to the second node; and
sending a first message requesting the first memory operation to the second node based on the identifier,
wherein the second node performs the first memory operation on the physical memory location.

2. The method of claim 1, further comprising:
translating the global system address to a virtualized address for the physical memory location, and
wherein the first message comprises the virtualized address.

3. The method of claim 2, wherein the virtualized address is translated to a physical address of the physical memory location before the first memory operation is performed.

4. The method of claim 1, wherein:
the identifier is a virtual node identifier, and
translating the global system address further comprises translating the virtual node identifier into a physical node identifier for the second node.

5. The method of claim 1, further comprising:
receiving, from a third node, a second message requesting a second memory operation, wherein the second message comprises a virtualized address of a physical memory location on the first node, and wherein the second memory operation corresponds to a second memory access request initiated on the third node;
translating the virtualized address to a physical address of the physical memory location on the first node; and
initiating the second memory operation on the physical memory location on the first node.

6. The method of claim 4, wherein data is stored into the physical memory location on the first node when the second memory operation is a store operation.

7. The method of claim 1, further comprising:
receiving data from the second node when the first memory operation is a load operation, and
sending the data to the processor.

8. The method of claim 1, further comprising:
requesting a physical memory page from the second node;
allocating a page in a global address space, wherein the page comprises the global system address;
receiving a virtualized address for the physical memory page; and
associating the virtualized address with the page in the global address space.

9. The method of claim 8, wherein the second node locks the physical memory page.

10. A system comprising:
a first node comprising a first physical memory and a first processor;
a second node comprising a second physical memory and a second processor; and
a first interconnect device operatively connected to the first processor, the first physical memory, and the second node, wherein
the first processor is configured to:
initiate a first memory access request comprising a process virtual address and a first memory operation, wherein the process virtual address is translated to a global system address, and wherein the global system address corresponds to a physical memory location in the second physical memory; and
the first interconnect interface device is configured to:
receive the global system address and the first memory operation;
translate the global system address to an identifier corresponding to the second node and a first virtualized address of the physical memory location in the second physical memory; and
send a first message requesting the first memory operation to the second node based on the identifier, wherein the first message comprises the first virtualized address,
wherein the second node performs the first memory operation on the physical memory location in the second physical memory.

11. The system of claim 10, further comprising:
an address space table configured to store a virtualized address for the physical memory location associated with an identifier for the second node, wherein the address space table is used to translate the globally system address to the identifier.

12. The system of claim 11, further comprising:
a node virtualization table configured associate a physical node identifier for the second node with the identifier for the second node.

13. The system of claim 10, further comprising:
a second interconnect interface device operatively connected to the second node and the first interconnect interface device, wherein the second interconnect interface device is configured to:
receive the first message;
translate the virtualized address to a physical address of the physical memory location; and
initiate the first memory operation on the physical memory location.

14. The system of claim 13 wherein the identifier is a network identifier for the second interconnect interface device.

15. The system of claim 10, wherein the first interconnect interface device is further configured to:
receive a second message requesting a second memory operation from the second node, wherein the second message comprises a second virtualized address of a physical memory location in the first physical memory, and wherein the second memory operation corresponds to a second memory access request initiated by the second processor;
translate the second virtualized address to a physical address of the physical memory location in the first physical memory; and
initiate the second memory operation on the physical memory location in the first physical memory.

16. The system of claim 14, wherein the first interconnect interface device is further configured to:
store data into the physical memory location in the first physical memory when the second memory operation is a store operation.

17. The system of claim 10, wherein the first interconnect interface device is further configured to:
receive data from the second node when the first memory operation is a load operation, and
send the data to the first processor.

18. An apparatus for memory address translation, the apparatus comprising:
logic to receive a first memory access request initiated by a first processor on a first node, wherein the first memory access request comprises a global system address and a first memory operation, and wherein the global system address corresponds to a physical memory location on a second node;
logic to translate the global system address to an identifier corresponding to the second node; and
logic to send a first message requesting the first memory operation to the second node based on the identifier, wherein the second node performs the first memory operation on the physical memory location.

19. The apparatus of claim 18, further comprising:
logic to receive a second message requesting a second memory operation from the second node, wherein the second message comprises a virtualized address of a physical memory location on the first node, and wherein the second memory operation corresponds to a second memory access request initiated on the second node;
logic to translate the virtualized address to a physical address of the physical memory location on the first node; and
logic to initiate the second memory operation on the physical memory location on the first node.

20. The apparatus of claim 18, further comprising:
logic to translate the global system address to a virtualized address of the physical memory location, wherein the first message comprises the virtualized address.
